(19) United States
(12) Patent Application Publication
(10) Pub. No.: US 2019/0124078 A1
(43) Pub. Date: Apr. 25, 2019

(54) SECURE INTERACTIVE VOICE RESPONSE

(71) Applicant: CA, Inc., Islandia, NY (US)

(72) Inventors: Junaid Ahmed Jameel, Bangalore (IN); Mohammed Mujeeb Kaladgi, Bangalore (IN); Ruqiya Nikhat Kaladgi, Bangalore (IN); Yashwant Ramkishan Sawant, Maharastra (IN)

(21) Appl. No.: 15/789,772

(22) Filed: Oct. 20, 2017

(51) Int. Cl. H04L 29/06; H04W 12/04; H04W 12/06

(52) U.S. Cl. CPC H04L 63/0861; H04L 63/083; H04W 12/06; H04L 63/067; H04W 12/04

(57) ABSTRACT

Aspects of the embodiments are directed to systems, methods, and computer program products that facilitate authentication of a user for providing authentication for access to secured services using an interactive voice response (IVR) service. A user device can include an application. The application can prompt the user to register with an authentication service to create an authentication credential. The user device can receive from the authentication service an authentication secret key. The application can prompt the user for a fingerprint scan, which the application can use to secure the authentication secret key. The user, when attempting to access a secured service, can provide another fingerprint scan to unlock the authentication secret key. The application can generate a one-time-password from the authentication secret key, and can transmit that OTP to an authentication service associated with the secured service provider. The authentication service can authenticate the user automatically using the OTP.

### FIELD

The present disclosure relates to interactive voice responses.

### BACKGROUND

Interactive voice response (IVR) is a technology that allows a computer to interact with humans through the use of voice and DTMF tones input via keypad. In telecommunications, IVR allows customers to interact with a company's host system via a telephone keypad or by speech recognition, after which services can be inquired about through the IVR dialogue. IVR systems can respond with prerecorded or dynamically generated audio to further direct users on how to proceed. IVR systems deployed in the network are sized to handle large call volumes and also used for outbound calling, as IVR systems are more intelligent than many predictive dialer systems.

IVR systems can be used for mobile purchases, banking payments and services, retail orders, utilities, travel information and weather conditions. A common misconception refers to an automated attendant as an IVR. The terms are distinct and mean different things to traditional telecommunications professionals—the purpose of an IVR is to take input, process it, and return a result, whereas the job of an automated attendant is to route calls. The term voice response unit (VRU) is sometimes used as well.

### BRIEF DESCRIPTION OF THE DRAWINGS

FIG. 1 is a schematic diagram of a system for providing a secure interactive voice response (IVR) in accordance with embodiments of the present disclosure.

FIG. 2 is a process flow diagram for associating an open authorization (OATH) with a fingerprint authentication in accordance with embodiments of the present disclosure.

FIG. 3 is a process flow diagram for generating and using a one-time password (OTP) for accessing an interactive voice response application in accordance with embodiments of the present disclosure.

### DETAILED DESCRIPTION

As will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely in hardware, entirely in software (including firmware, resident software, micro-code, etc.) or combining software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language, such as JAVA.®., SCALA.®., SMALLTALK.®., EIFFEL.®., JADE.®., EMERALD.®., C++, C#, VB.NET, PYTHON.®. or the like, conventional procedural programming languages, such as the “C” programming language, VISUAL BASIC.®., FORTRAN.®. 2003, Perl, COBOL 2002, PHP, ABAP.®., dynamic programming languages such as PYTHON.®., RUBY.®. and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatuses (systems) and computer program products according to aspects of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

The terminology used herein is for the purpose of describing particular aspects only and is not intended to be limiting of the disclosure. As used herein, the singular forms “a,” “an,” and “the” are intended to comprise the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

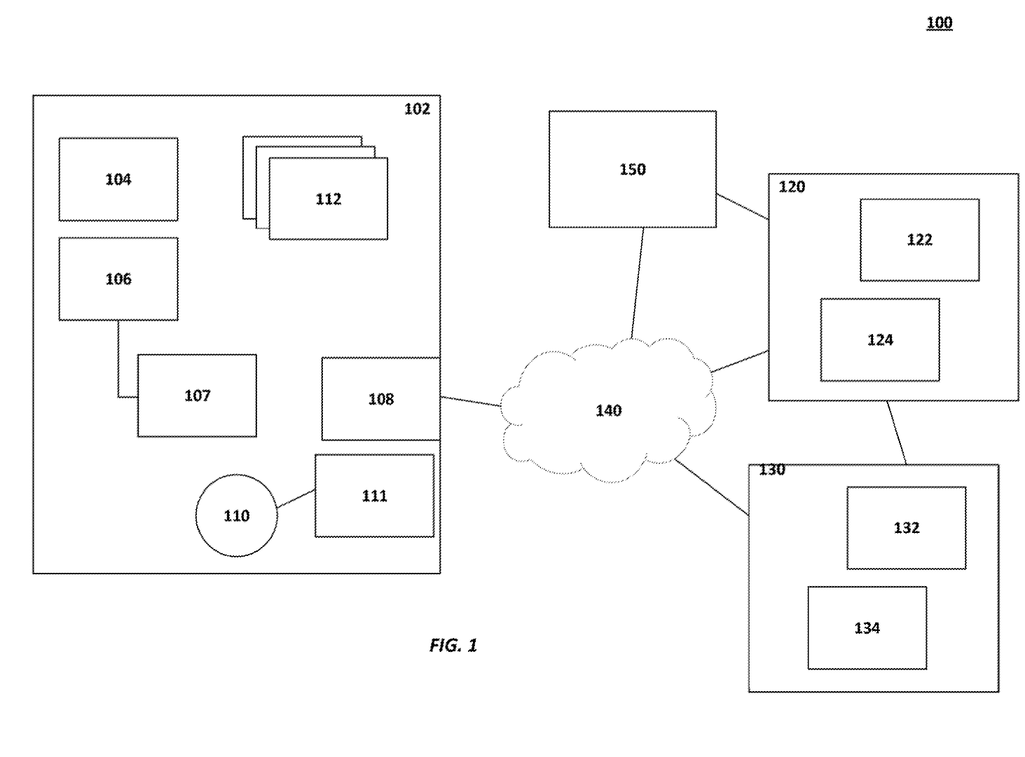

FIG. 1 is a schematic diagram of a system 100 for performing secure interactive voice response in accordance with embodiments of the present disclosure. System 100 includes a user device 102, such as a mobile phone, tablet PC, smart phone, or other mobile device. The user device 102 can also be a voice control system, such as an AMAZON ECHO™ or AMAZON ALEXA™ or other voice control system. User device 102 can include a processor 104. Processor 104 can be a processor at least partially implemented in hardware, but can also include software. The user device 102 can include a memory 106. Memory 106 can be a hardware storage device, such as a magnetic hard drive, flash memory, solid state memory, insertable memory card, etc. The memory 106 can be a secured storage location or can include an allocation of memory that is secured (e.g., memory location 107). The secured storage can be password protected and/or protected by other techniques, such as by biometric information.

The user device 102 can include a fingerprint scanner 110. Fingerprint scanner 110 can include an optical scanner or a capacitive scanner. Fingerprint scanner 110 can be controlled by fingerprint scanning software 111. Fingerprint scanning software 111 can include software that facilitates collection of fingerprints and identification of a user via fingerprint matching algorithms.

The user device 102 can include one or more applications. An application 112 can include an interface to an secured system 120. The application 112 can be used to authenticate a user attempting to use a secured system 120 using a stored fingerprint associated with the user and with an authentication credential. The application 112 can cause the user device 102 to send and receive messaging through wired or wireless signaling through a network 140 using a transceiver 108. The application 112 can use biometric information, such as fingerprint information, to authenticate a user to allow a user to use securely a network-based secured system 120. Though shown as connected through a network 140, the secured system 120 can also be local to the user device 102.

In embodiments, the application 112 can be an application that can be downloaded from the secure server 120 after a user registers with the secure server 120. The application 112 can also be triggered when a user attempts to access the secured server 120. The application 112 can coordinate a user's credentials with the secured system 120 for granting access to the secured server 120 using a user's biometric information, such as by prompting the user to provide a fingerprint scan to access the secured server 120. The secure server 120 can be, e.g., a server for a bank or credit card or other financial institution, or other type of secure transaction services server.

The secured system 120 can include a processor 122. Processor 122 can process commands from the user to return a correct response or generate instructions to perform a task. The secured system 120 can also include an authentication service 124. Authentication service 124 can be an application that can authenticate a user and provide the user with an OATH secret key. In embodiments, the secured system 120 can also communicate with an authentication server 130.

The user device 102 can authenticate the user using the authentication server 130. Authentication server 130 can generate an open authentication (OATH) secret key for the user through an authentication process, such as a public/private key or other authentication process. The authentication service 130 can also communicate with the secured system 120 to authenticate a user's attempt to access and use the secured system 120 using, e.g., a fingerprint scan or other unique biometric data.

In embodiments, a user can register with the secured server 120. The secured server 120 can prompt the user to download or cause the user device 102 to download an application 112. When the user, through the user device 102, attempts to use a service provided by the secure server 120, the secure server 120 can use an IVR service 150 to call the user device 102. The IVR service 150 can be used to ensure that the transaction being attempted is from the authorized user, and not from an unauthorized third party. The IVR service 150 can prompt the user to provide a biometric identifier, such as a fingerprint scan, to authenticate herself with the secured server 120. The secure server 120 can authenticate the user using the unique biometric identifier using, e.g., an authentication server 130.

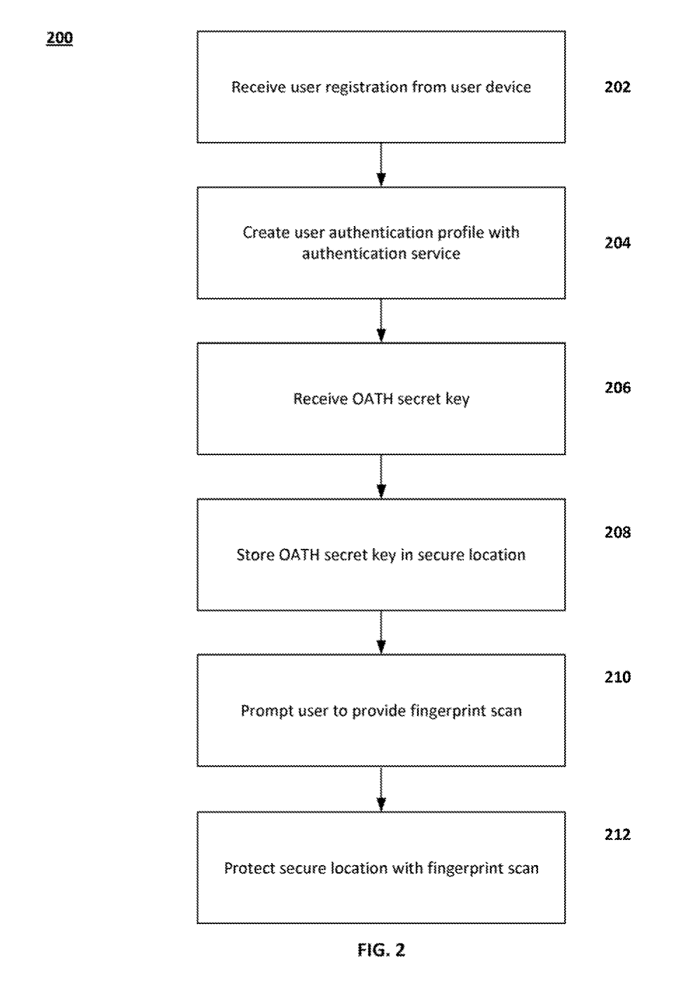

FIG. 2 is a process flow diagram 200 for associating an open authorization (OATH) with a fingerprint authentication in accordance with embodiments of the present disclosure. At the outset, a user can register with a secured server (202). The secured server can use an authentication service to create an authentication profile for the user (204). The authentication procedure can be any authentication procedure that can create an authentication key for the user. For example, the user can undergo a public/private certification process with an authentication service. The authentication service can issue an authentication key, such as an open authentication secret key (OATH secret key). The application on the user device can then receive the OATH secret key from the authentication service (206) and can store the OATH secret key in a secure location (208).

The application can, at any time during the registration process, prompt the user to register a fingerprint to provide additional security and user authentication (210). The user can use a fingerprint scanner on or attached to the user device to provide one or more fingerprint scans (e.g., multiple scans of a single finger and/or scans of multiple fingers). The application can lock the secure location using the fingerprint (212). The application can also associate the OATH secret key received from the application service with one or more of the fingerprints scanned during registration process. For example, the application can store the fingerprint scan(s) in memory

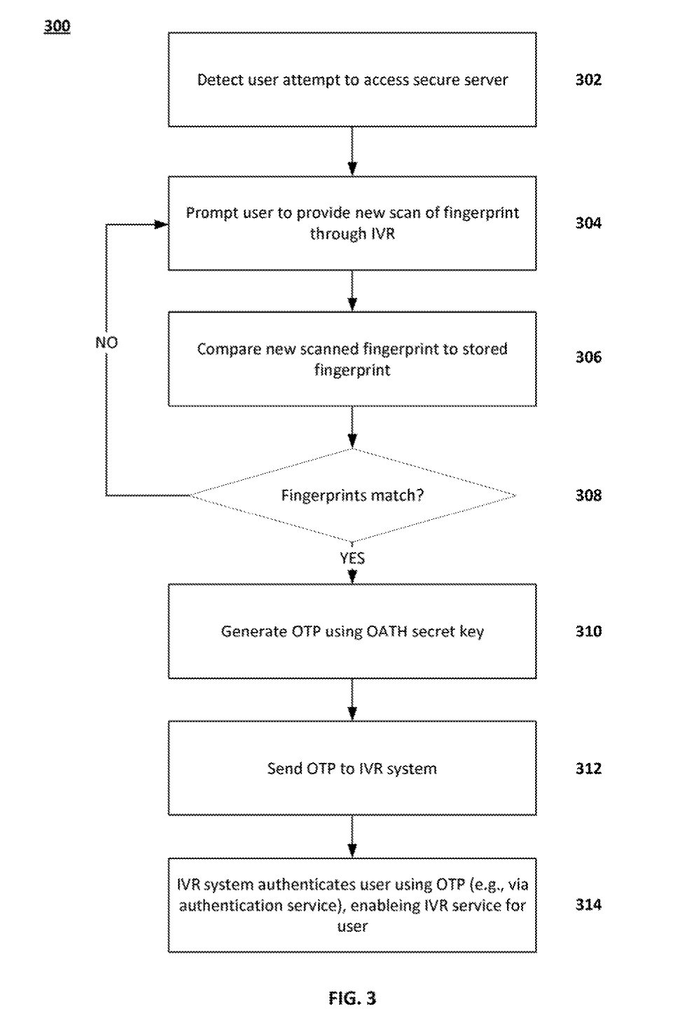

FIG. 3 is a process flow diagram 300 for generating and using a one-time password (OTP) for accessing an interactive voice response application in accordance with embodiments of the present disclosure. At the outset, a user operating a user device can initiate a secured transaction with the secured server (302). For example, the user can use an application associated with the secured server through the user device. The secured server can trigger a cellular or IP call to the user device, which makes use of an IVR system prompting the user to provide biometric information (304). For example, the application can prompt the user to provide a fingerprint scan that the application can use to authenticate the user.

The application can authenticate the user by first comparing the new fingerprint scanned against one stored with the user device and associated with the OATH stored in the secure memory location (306). The comparison of the finger print scans can use pattern matching algorithms or other techniques used for fingerprint comparisons. The application can determine whether the scanned fingerprint matches a stored fingerprint (308). If the application determines that the scanned fingerprint does not match the stored fingerprint, the application can repeat the prompt for a fingerprint scan without giving access to the IVR system (304). If the application determines that the scanned fingerprint does match the stored fingerprint, the application can retrieve the OATH associated with the fingerprint and stored in the secure memory location on the user device and can generate a one-time password (OTP) from the OATH (310). The application can transmit the OTP to a secured system (312). The application can use a transceiver on the user device to transmit the OTP to a remote secured system across a network.

The secured system can authenticate the user using the OTP using, for example, and authentication service, such as the authentication service the user used to perform the aforementioned authentication or registration process.

The figures illustrate the architecture, functionality, and operation of possible implementations of systems, methods, and computer program products according to various aspects of the present disclosure. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

The corresponding structures, materials, acts, and equivalents of any means or step plus function elements in the claims below are intended to include any disclosed structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

While the present disclosure has been described in connection with preferred embodiments, it will be understood by those of ordinary skill in the art that other variations and modifications of the preferred embodiments described above may be made without departing from the scope of the disclosure. Other embodiments will be apparent to those of ordinary skill in the art from a consideration of the specification or practice of the disclosure disclosed herein. It will also be understood by those of ordinary skill in the art that the scope of the disclosure is not limited to use in a server diagnostic context, but rather that embodiments of the disclosure may be used in any transaction having a need to monitor information of any type. The specification and the described examples are considered as exemplary only, with the true scope and spirit of the disclosure indicated by the following claims.

What is claimed is:

1. A computer-implemented method for authenticating a user across an interactive voice response (IVR) service, the method comprising:
prompting a user, via the IVR service, to provide a fingerprint scan;
receiving, from a fingerprint scanner, a scan of a fingerprint of a user attempting to access a secured service;
comparing the fingerprint scan received from the fingerprint scanner against a stored scan of the fingerprint;
determining that the fingerprint scan received from the fingerprint scanner is a match to the stored scan of the fingerprint;
generating a one-time password (OTP) from an open authentication (OATH) secret key associated with the stored scan of the fingerprint;
transmitting the OTP to a secured server for authenticating the user; and
authenticating the user to use the secured service.

2. The computer-implemented method of claim 1, further comprising:
prior to receiving the scan of the fingerprint:
receiving, from the user, a request for the secured service;
contacting the user via the IVR service; and
prompting the user to provide the scan of the fingerprint for authentication purposes in response to receiving the request for the secured service from the user.

3. The computer-implemented method of claim 1, wherein determining that the fingerprint scan received from the fingerprint scanner is a match to the stored scan of the fingerprint comprises performing an image-based pattern matching between the scanned fingerprint and the stored scan of the fingerprint.

4. The computer-implemented method of claim 1, wherein generating a one-time password (OTP) from an open authentication (OATH) secret key associated with the stored scan of the fingerprint comprises generating a time-based OTP that is configured to expire after a predetermined amount of time.

5. A non-transitory computer-readable medium having program instructions stored therein, wherein the program instructions are executable by a computer system to perform operations comprising:
receiving, from a fingerprint scanner, a scan of a fingerprint of a user attempting to access a secured server;
comparing the fingerprint scan received from the fingerprint scanner against a stored scan of the fingerprint;
determining that the fingerprint scan received from the fingerprint scanner is a match to the stored scan of the fingerprint;
generating a one-time password (OTP) from an open authentication (OATH) secret key associated with the stored scan of the fingerprint;
transmitting the OTP to the secured server to authenticate the user; and
authenticating the user to access the secured server.

6. The non-transitory computer-readable medium of claim 5, the operations further comprising:
receiving, from the user, a request for the secured server prior to receiving the scan of the fingerprint; and
contacting the user via the IVR service; and
prompting the user to provide the scan of the fingerprint for authentication purposes in response to receiving the request for the secured service from the user.

7. The non-transitory computer-readable medium of claim 5, the operations further comprising:
using a pattern matching algorithm to compare the prompted fingerprint scan with the stored fingerprint scan.

8. A non-transitory computer-readable medium of claim 5, the operations further comprising generating a time-based OTP that is configured to expire after a predetermined amount of time.

9. A computer-implemented method comprising:
prompting a user to perform a registration that includes a user authentication;
receiving from an authentication service an authentication key for the user;
storing the authentication key in a memory location; and
securing the memory location using an image of a fingerprint of the user.

10. The method of claim 9, further comprising:
prompting the user to provide a scan of a fingerprint;
receiving the scan of the fingerprint; and
securing the memory location containing the authentication key with the scan of the fingerprint.

11. The method of claim 9, further comprising associating the scan of the fingerprint with the authentication key.

12. The method of claim 9, further comprising storing multiple scans of the fingerprint at different locations of the user's finger, and securing the memory location using one of the multiple scans of the fingerprint.

13. The method of claim 9, further comprising:
receiving an indication from the user to use a secured server;
prompting the user to provide a new scan of a fingerprint;
receiving, from a fingerprint scanner, a scan of a fingerprint of the user attempting to access the secured server;
comparing the fingerprint scan received from the fingerprint scanner against a stored scan of the fingerprint;
determining that the fingerprint scan received from the fingerprint scanner is a match to the stored scan of the fingerprint;
accessing an authentication key protected by the fingerprint scan;
generating a password from authentication key; and
transmitting the password to an authentication server to authenticate the user using the password.

14. The method of claim 9, wherein the authentication key is an open authentication secret key, and the password is a one-time password (OTP).

15. A non-transitory computer readable medium having program instructions stored therein, wherein the program instructions are executable by a computer system to perform operations comprising:
prompting a user to perform a registration that includes a user authentication;
receiving from an authentication service an authentication key for the user;
storing the authentication key in a memory location; and
securing the memory location using a scan of a fingerprint of the user.

16. The non-transitory computer readable medium of claim 15, operations further comprising:
prompting the user to provide a scan of a fingerprint;
receiving the scan of the fingerprint; and
securing the memory location containing the authentication key with the scan of the fingerprint.

17. The non-transitory computer readable medium of claim 15, the operations further comprising associating the scan of the fingerprint with the authentication key.

18. The non-transitory computer readable medium of claim 15, the operations further comprising receiving multiple scans of the fingerprint at different locations of the user's finger;
and securing the memory location using the multiple scan of the fingerprint

19. The non-transitory computer-readable medium of claim 15, the operations further comprising:
receiving an indication from the user to use an IVR service;
prompting the user to provide a new scan of a fingerprint;
receiving, from a fingerprint scanner, a new scan of a fingerprint of the user attempting to access the IVR service;
comparing the new scan of the fingerprint received from the fingerprint scanner against a stored scan of the fingerprint;
determining that the fingerprint scan received from the fingerprint scanner is a match to the stored scan of the fingerprint;
accessing an authentication key protected by the fingerprint scan;
generating a password from authentication key; and
transmitting the password to an authentication server to authenticate the user using the password.

20. The non-transitory computer-readable medium of claim 15, wherein the authentication key is an open authentication secret key, and the password is a one-time password (OTP).
